(19) United States
(12) Patent Application Publication
(10) Pub. No.: US 2014/0020294 A1
(43) Pub. Date: Jan. 23, 2014

(54) Out of the Earth Plant Re Grounding Rod

(71) Applicants: LeRoy Charles Dunning, Austin, TX (US); Pamela McKenzie, Austin, TX (US); Scott Vincent Miscall, Austin, TX (US)

(72) Inventors: LeRoy Charles Dunning, Austin, TX (US); Pamela McKenzie, Austin, TX (US); Scott Vincent Miscall, Austin, TX (US)

(73) Assignee: Leroy Charles Dunning, Austi, TX (US)

(21) Appl. No.: 13/551,612

(22) Filed: Jul. 18, 2012

(51) Int. Cl. A01G 7/04

(52) U.S. Cl. CPC A01G 7/04
USPC 47/62 R; 47/1.3

(57) ABSTRACT

A method to reconnect plants with the natural electron charge of the earth when grown out of the earth in containers no longer connected to the earth is disclosed. The method includes parts to combine into many configurations to provide a grounding connected to an earth ground or house ground to conductively couple indoor container potted plants and hydroponic growing systems to the abundant supply of free electrons from the earth to re create the same electrically charged growing environment as when planted in the earth. In this way growing plants can benefit by the Earths' mobile free electron charge applied to the growing medium

### BACKGROUND OF THE INVENTION

The present system relates to grounding systems. More particularily, the present invention relates to a means of collecting and transporting electrons to un grounded growing systems; container growing, hydroponic systems and cut flowers in water in a vase. When living plant systems are planted in the earth as was the case throughout evolution, the biological systems that developed on earth attenuated the negative electrical properties of the earth and the plant became neutral like the earth. In the case of growing plants no longer connected to the naturally occurring rebalancing electron field of the earth, the chemical changes producing free radicals from plant cellular metabolic synthesis can be brought back into balance by reducing the positive ions of metabolism by subsequent charge cancellation allowing for continued growth or extended cut flower life by re grounding them when they are no longer connected e.g., planted in the earth.

### SUMMARY OF THE INVENTION

The present invention relates to a means of grounding out-of-the-earth growing systems to enable plants to have healthy growth even in high rise apartment growing situations by using the common ground found in all electrically wired sockets in any dwelling. The natural electrical potential of earth grounding can thereby be produced at any altitude to re create the conditions that growing plants experience planted in the earth at ground level by this useful and unique invention utilizing a grounding rod that is inserted in a detached growing medium e.g., when the plant is insulated from contact with the earth. Plants grown at ground level in a house for instance can also use an outdoor grounding rod connected to the present system to re connect indoor plants to the earths' electric field ground.

### BRIEF DESCRIPTION OF THE DRAWINGS

The accompanying drawings illustrate the invention. In such Drawings:

FIG. 1 is a cross section of parts showing the various parts of the invention and how they fit together in a typical grounding apparatus for use.

FIG. 2 is a cross section of parts showing the individual parts and their construction

### DETAILED DESCRIPTION OF THE PREFERRED EMBODIMENTS

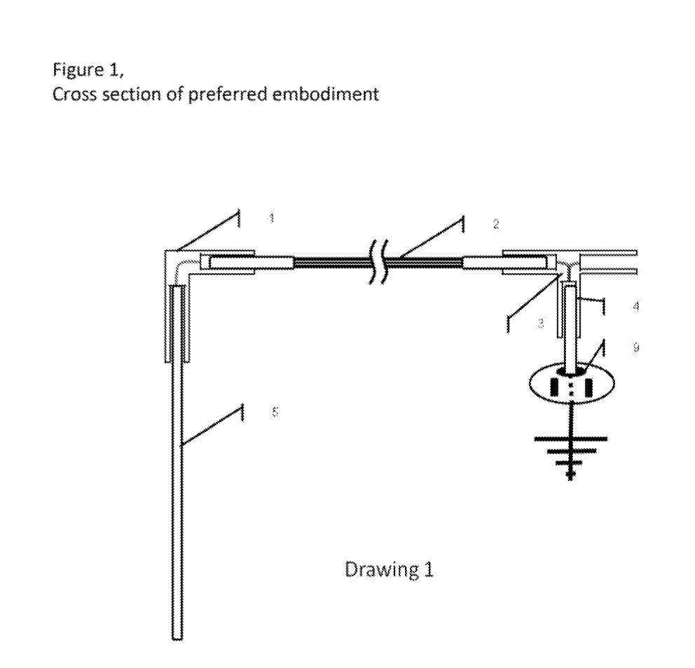

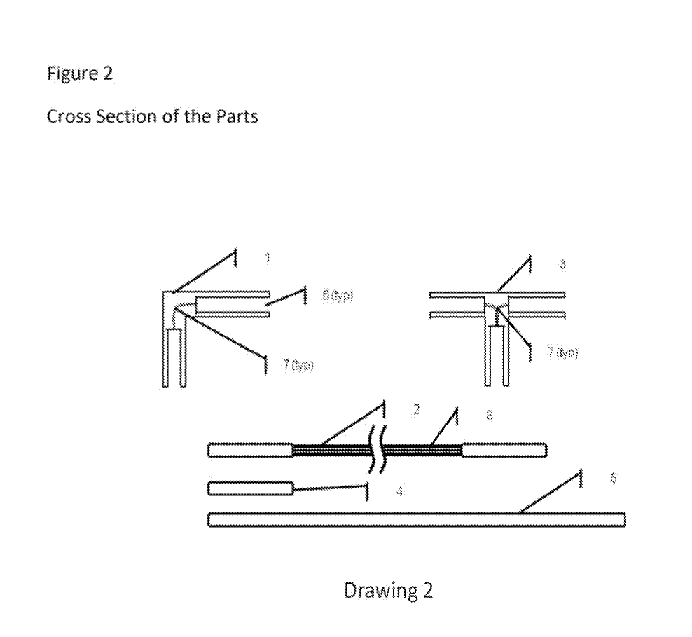

A preferred embodiment is described referring to the attached drawings FIG. 1 and FIG. 2.

A stainless steel or copper ground rod (5) for earth insertion or a common electrical socket grounding pin (4) is inserted into a common 45 degree elbow connector (1) constructed of an insulating plastic material with two female sockets (6 (typ)) connected with a wire (7 (typ)) as shown in cross section in drawing 2. The 45 degree elbow connector can also accept another male grounding pin (4) constructed of stainless steel or brass in order to connect the insulated wire conductor wire (2) that has two male grounding pins (4) welded to the wire ends of the wire connector (2) to be used as a common connector within the design of the invention. A second common connector constructed with an insulating plastic material with three female ground sockets (6 (typ)) in the shape of a “T” with all sockets connected by a common internal wire (7 (typ)) can connect the common connector wire to an end ground rod (5) that is inserted in the 45 degree elbow connector that can be either an earth-inserted end when used with a second ground rod (5) as the indoor plant or flower vase inserted end (not depicted), OR as shown in the FIG. 1 by using a grounding pin (4) in the T shaped common connector when using an electrical outlet ground receptacle socket (9) as the means of connecting to earth ground as shown in Drawing 1. The end ground can be stainless steel or copper rod of varying lengths (5) that are interchangeable and can is inserted into soil, reservoir or flower vase to accommodate any depth of out of the earth growing or cut flower container. Additional end grounds leading to more containers can be connected by the common junction adapter (3) that has three ground lead sockets (7 (typ)) to accommodate many end ground pins onto a single grounded multi end ground lead system. The conductor wire is constructed of insulated copper wire to assure electron transport from the ground connection rod or pin to the end ground in all cases.

Part 1 is a 45 degree angle connector with a grounding lead socket that can accept either the grounding pin from a common connector wire with its two grounding pins, or one of several lengths of copper end ground attachments.

Part 2 is a common connector wire (2) of varying lengths soldered to ground pins (4) at both ends to connect to either a 45 degree angle connector (1) or to a T connector (3).

Part 3 is a T shaped connector with only grounding sockets to interconnect many part 2 and part 1 combinations as well as male ground pins and copper rods.

Part 4 is a electrical socket grounding pin (4) to enable the system to connect to earth ground via an electrical socket ground.

Part 5 is a set of different copper grounding end ground rods (5) for indoor plant insertion or outside earth insertion to establish a ground for the completed system.

In that these parts can be assembled in any number of combinations many systems can be constructed to accommodate all configurations of containerized or hydroponic plant systems, potted plants but also any number of cut flower vases to extend the freshness of cut flowers in many individual vases.

This commonality of parts and versatility is a unique feature of the current invention

What is claimed is:

1. A means of conducting earth produced free electrons into growing mediums for improving plant vigor by a wire and conducting grounding rods constructed of copper and/or stainless steel. A ground lead is connected to an earth ground in the soil or an electrical outlet ground receptacle that is attached to a conducting wire with the opposite end attached to a conducting copper rod that can be inserted into the plant growing medium.

2. The earth ground is inserted directly in to the earth.

3. The earth ground is inserted into a house electrical outlet socket ground

4. The grounding rod is inserted into a hydroponic reservoir

5. The grounding rod is inserted into the soil in a container flower pot

6. The grounding rod is inserted into the water of a cut flower vase

7. The grounding wire can be connected to a junction to allow more than one earth ground lead to accommodate many individual container grown plants, hydroponic growing reservoirs or cut flower vases.

8. The junction can connect many parts to conduct from one grounded lead.

9. A many part system of interconnectors to configure any number of arrangements to accommodate any number of out-of-the-earth plants.
